(19) United States
(12) Patent Application Publication
(10) Pub. No.: US 2015/0298977 A1
(43) Pub. Date: Oct. 22, 2015

(54) METHOD FOR FORMING GRAPHENE QUANTUM DOT

(71) Applicant: GRAPHENEALL, Gyeonggi-do (KR)

(72) Inventor: Yeo Heung Yoon, Asan-si (KR)

(73) Assignee: GRAPHENEALL CO., LTD., Suwon-si, Gyeonggi-do (KR)

(21) Appl. No.: 14/646,654

(22) PCT Filed: Oct. 10, 2013
(86) PCT No.: PCT/KR2013/009050

§ 371 Date: May 21, 2015

(30) Foreign Application Priority Data
Nov. 21, 2012 (KR) 10-2012-0132589

(51) Int. Cl. C01B 31/04

(52) U.S. Cl. CPC C01B 31/0438

(57) ABSTRACT

In a method for forming a graphene quantum dot, a first reduced graphene oxide product having a first size is formed by applying microwaves to a graphene oxide material. The first reduced graphene oxide product is oxidized by applying microwaves to a mixed solution including an acid solution, a first oxidant, and the first reduced graphene oxide product so as to form a first graphene oxide product having a second size. Microwaves are applied to the first graphene oxide product so as to form a second reduced graphene oxide product having a third size which is smaller than the first size.

### TECHNICAL FIELD

One or more exemplary embodiments relate to a method of forming a graphene quantum dot, and more particularly, to a method of forming graphene oxide quantum dot and a reduced graphene oxide quantum dot.

### BACKGROUND ART

Recently, research into graphene with useful mechanical and electrical characteristics has been conducted in various aspects. In order to obtain a graphene quantum dot material, graphene having a micro size that is enough to generate a quantum phenomenon needs to be produced. Accordingly, research has been conducted into various processes for obtaining graphene oxide or graphene from a graphite source material.

In forming graphene oxide having a micro size that is enough to generate a quantum phenomenon through an oxidation process of graphite, conventional methods that have been suggested so far take so much time that a large amount of acid may penetrate into the final graphene oxide product after synthesis of the final graphene oxide product. This makes it difficult to separate the acid from the final graphene oxide product. Furthermore, in a method of forming reduced graphene oxide having a micro size from graphene oxide having a micro size, methods proposed up to now include a high temperature process or use a toxic material, which may cause a harmfulness problem. Thus, research into an environmentally-friendly reduction method is necessary.

### DETAILED DESCRIPTION OF THE INVENTION

### Technical Problem

One or more exemplary embodiments include a method of forming a graphene oxide in a simplified and environmentally-friendly way.

### Technical Solution

One or more exemplary embodiments include a method of forming a graphene quantum dot. A first reduced graphene oxide product may be formed by applying microwaves to a graphene oxide material. A first graphene oxide product may be formed by oxidizing the first reduced graphene oxide product while applying microwaves to a mixture solution including an acid solution, a first oxidant, and the first reduced graphene oxide product. A second reduced graphene oxide product may be formed by applying microwaves to the first graphene oxide product.

One or more exemplary embodiments include a method of forming a graphene quantum dot. A reduced graphene oxide product may be formed by reducing a graphene oxide material using microwaves. A repetitive oxidation operation of forming a graphene oxide product may be performed by oxidizing the reduced graphene oxide product again. A repetitive reduction operation of forming the reduced graphene oxide product may be performed by reducing the graphene oxide product again using microwaves. At least one of the repetitive oxidation operation and the repetitive reduction operation may be repeated with respect to the reduced graphene oxide product obtained in the repetitive reduction operation at least once.

### Advantageous Effects

As described above, according to the one or more exemplary embodiments, a graphene quantum dot may be formed in an environmentally-friendly way during a simple process, and an oxidation/reduction process may be used at a low process cost, which enables mass production of graphene quantum dots, thereby improving productivity.

### DESCRIPTION OF THE DRAWINGS

FIG. 1 is a flowchart for describing a method of forming a graphene quantum dot, according to exemplary embodiments;

FIG. 2 is a flowchart for describing a process of forming a first graphene oxide product in a method of forming a graphene quantum dot, according to exemplary embodiments;

FIG. 3 is a flowchart for describing a recycle oxidation process according to an example of reusing an acid solution in a method of forming a graphene quantum dot according to exemplary embodiments;

FIG. 4 is a flowchart for describing a recycle oxidation process according to another example of reusing acid in a method of forming a graphene quantum dot according to other exemplary embodiments;

FIG. 5 is a flowchart for describing a recycle oxidation process that reuses an acid solution to obtain a graphene oxide material used as a reactant before forming a first reduced graphene oxide product in a method of forming a graphene quantum dot according to other exemplary embodiments;

FIG. 6 is a schematic diagram illustrating a device for forming a graphene quantum dot, according to exemplary embodiments;

FIG. 7 is a flowchart for describing a reduction process according to an example of forming a reduced graphene oxide in a method of forming a graphene quantum dot according to exemplary embodiments;

FIG. 8 is a flowchart for describing a reduction process according to another example of forming a reduced graphene oxide in a method of forming a graphene quantum dot according to exemplary embodiments;

FIG. 9 is a flowchart for describing a reduction process according to another example of forming a reduced graphene oxide in a method of forming a graphene quantum dot according to exemplary embodiments;

FIGS. 10A through 10E are graphs for describing various methods of applying microwaves in a method of forming a graphene quantum dot according to exemplary embodiments; and

FIG. 11 is a graph illustrating a result of measuring an ultraviolet-visible (UV-Vis) spectrum of a reduced graphene oxide quantum dot obtained by using a method of forming a graphene quantum dot according to exemplary embodiments.

### BEST MODE

The invention now will be described more fully hereinafter with reference to the accompanying drawings, in which illustrative embodiments of the invention are shown. Like numbers refer to like elements throughout, and descriptions of such like or same elements will not be repeated.

This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

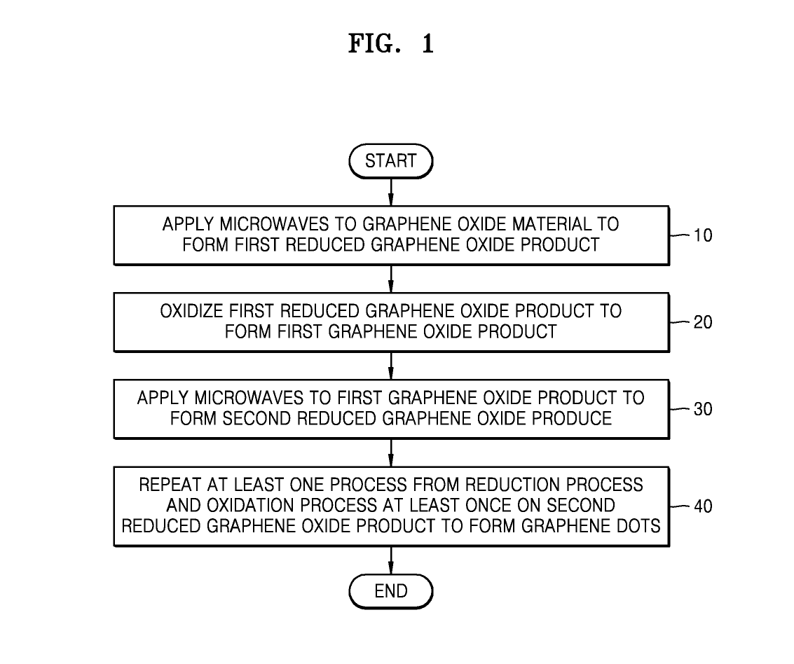

FIG. 1 is a flowchart for describing a method of forming a graphene quantum dot according to exemplary embodiments.

Referring to FIG. 1, in process 10, a first reduced graphene oxide product having a first size is formed by applying microwaves to a graphene oxide material and reducing graphene oxide.

If microwaves are applied to the graphene oxide material, since graphene oxide particles constituting the graphene oxide material split, particle sizes become smaller, and thus graphene oxide may be changed to reduced graphene oxide.

In some exemplary embodiments, the graphene oxide material may only include graphene oxide powder.

In some other exemplary embodiments, the graphene oxide material may include a polar solvent and graphene oxide powder dispersed in the polar solvent. The polar solvent may include water or an organic solvent. For example, the polar solvent may include propionitrile, dimethyl sulfoxide, acetonitrile, N-methylformamide, dimethylformamide, N-methylacetamide, formamide, nitromethane, acetone, water, ethyl acetate, tetrahydrofuran, acetic acid, methanol, ethanol, n-propanol, isopropanol, n-butanol, dichloromethane, formic acid, diethyl ether, chloroform, toluene, or a combination thereof.

In some other exemplary embodiments, the graphene oxide material may include a neutral or alkaline solution and graphene oxide dispersed in the neutral or alkaline solution. The neutral or alkaline solution may be a resultant obtained by neutralizing an acid solution. For example, the neutral or alkaline solution may be obtained by oxidizing graphite that is an initial reactant by using the acid solution, forming a graphene oxide product, without separating or recovering the acid solution, applying an alkaline material such as NaOH or KOH to the graphene oxide material and a reaction resultant in which the acid solution remains, and neutralizing the acid solution remaining in the reaction resultant.

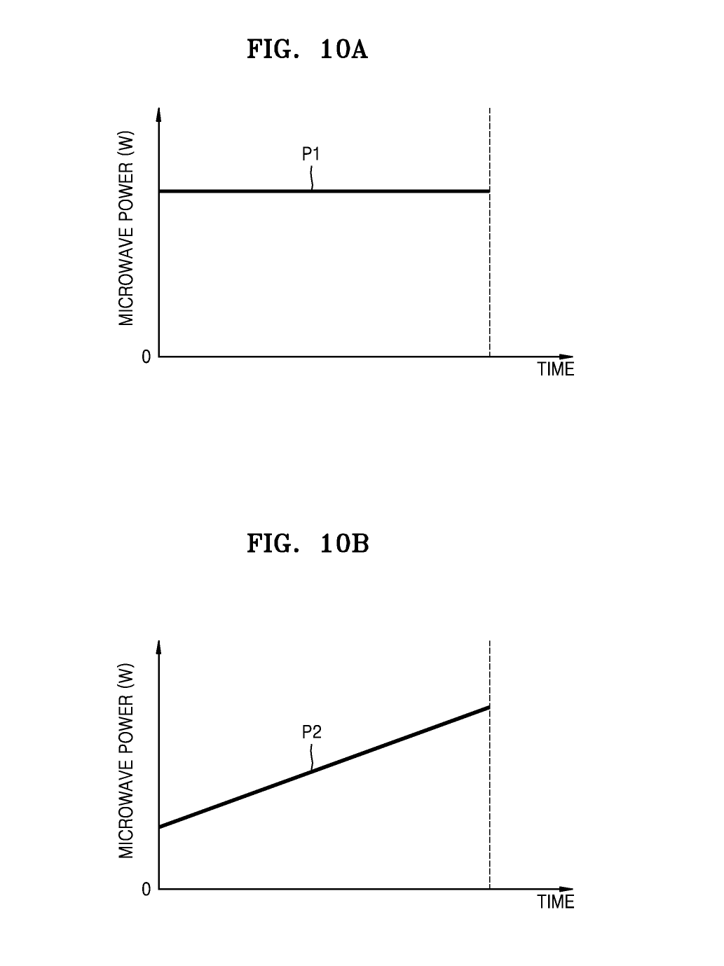

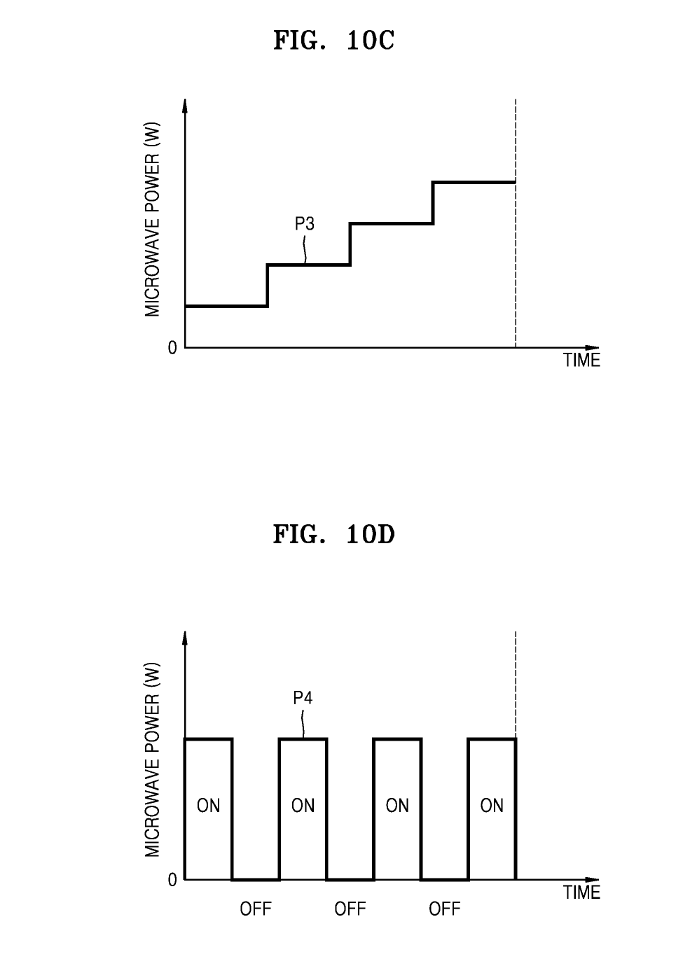

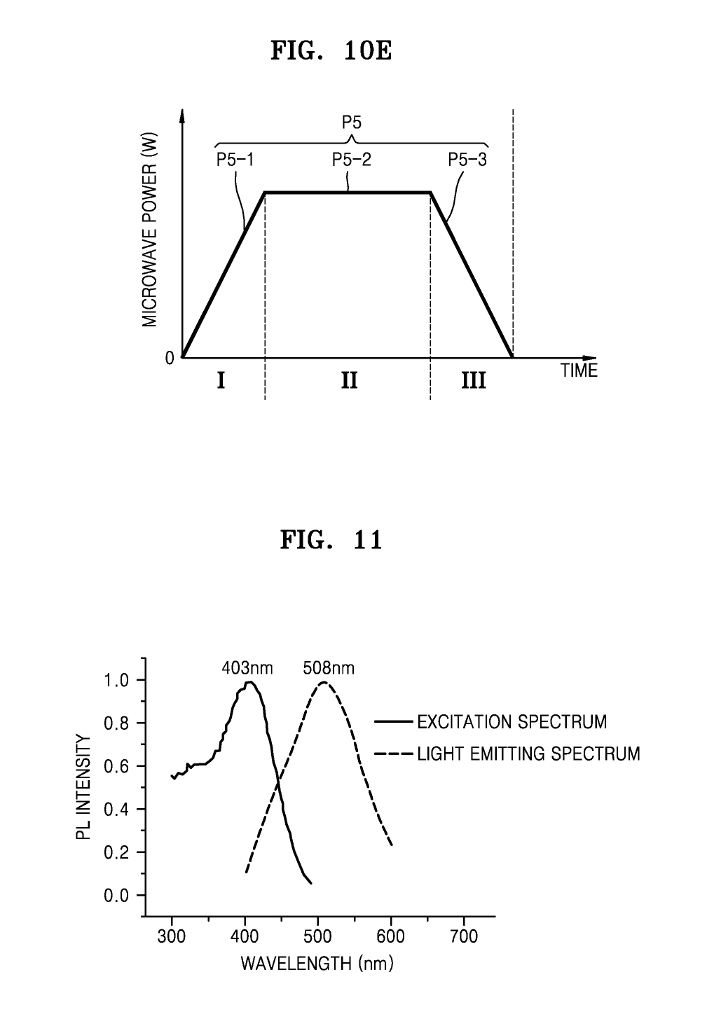

In forming the first reduced graphene oxide product according to process 10, a detailed method of applying microwaves to the graphene oxide material will be described with reference to FIGS. 10A and 10E later.

In process 20 of FIG. 1, a second reduced graphene oxide product is formed by oxidizing the first reduced graphene oxide product again by applying microwaves to a mixture solution containing the acid solution, a first oxidant, and the first reduced graphene oxide product obtained in process 10.

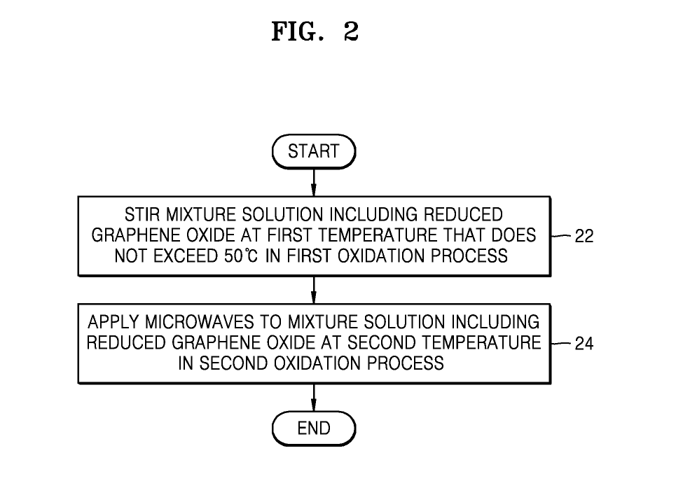

FIG. 2 is a flowchart for describing a process of forming a first graphene oxide product in process 20 of FIG. 1 according to exemplary embodiments.

Referring to FIG. 2, a first oxidation process in process 22 and a second oxidation process in process 24 are sequentially performed to form the first graphene oxide product in process 20 of FIG. 1.

The first oxidation process in process 22 may include stirring a mixture solution containing a first reduced graphene oxide product obtained in process 10, an acid solution, and an oxidant at a first temperature that does not exceed 50° C.

In some exemplary embodiments, the acid solution may include at least one selected from sulfuric acid, phosphoric acid, sodium nitrate, potassium persulfate, phosphorus pentoxide, chlorosulfonic acid, fluorosulfonic acid, oleum, and acetic acid.

In some exemplary embodiments, the oxidant may be selected from permanganate, ferrate, osmate, ruthenate, chlorate, chlorite, nitrate, osmium tetroxide, ruthenium tetroxide, lead dioxide, hexavalent chromium ions (CrO₃⁻, Cr₂O₇⁻, chromate, dichromate, and pyridinium chlorochromate (PCC)), hydrogen peroxide (H₂O₂), silver oxide (Ag₂O), ozone (O₃), and a combination thereof. For example, the oxidant may be potassium permanganate.

In some exemplary embodiments, the first oxidation process in process 22 may be performed at a temperature of about 5° C. to about 10° C. The first oxidation process may be performed for about 1 minute to about 60 minutes. In some exemplary embodiments, a first oxidation process time may not exceed 10 minutes. The first oxidation process corresponds to an initial oxidation step for forming graphene oxide. If a reaction temperature of the initial oxidation step is too high, an explosion is likely to occur due to a sudden oxidation reaction. To eliminate the possibility of an explosion, the reaction temperature of the first oxidation process may be maintained at a temperature of about 50° C. or lower.

The second oxidation process in process 24 may include applying microwaves to the mixed solution containing reduced graphene oxide at a second temperature. The second temperature may be controlled not to exceed 60° C. For example, the second oxidation process may be performed at a temperature of about 20° C. to about 50° C. In some exemplary embodiments, the second oxidation process may be performed for about 1 minute to about 60 minutes. If the temperature of the mixed solution increases too high, an unwanted reduction reaction of the graphene oxide synthesized from the mixed solution may occur. To prevent the reduction of the graphene oxide obtained from the mixed solution, the temperature of the mixed solution needs to be effectively controlled during the second oxidation process. To effectively control the temperature of the mixed solution during the second oxidation process, microwaves may be applied to the mixed solution in various ways. In some exemplary embodiments, in the second oxidation process in process 24, microwaves of about 100 W to about 800 W may be applied to the mixed solution containing the first reduced graphene oxide product, an acid solution, and an oxidant. A detailed method of applying microwaves to oxidize the first reduced graphene oxide product again in process 24 will be described later with reference to FIGS. 10A and 10E.

The second oxidation process includes applying microwaves, which may shorten the time necessary for oxidizing the first reduced graphene oxide product. If the time necessary for oxidizing the first reduced graphene oxide product is too long, since a strong acid used in an oxidation reaction may permeate deeply into a graphene oxide structure that is a reaction product, it may not be easy to recover acid from the graphene oxide product. In this aspect, a shorter oxidation process time of the first reduced graphene oxide product may be advantageous. In some exemplary embodiments, microwaves are applied in the oxidation process of the first reduced graphene oxide product, and thus, the time necessary for the oxidation process may be shortened, and accordingly, the acid may be easily recovered from the reaction product.

As a result of oxidizing the first reduced graphene oxide product through the second oxidation process in process 24, a first graphene oxide product having a structure of several to tens of layers of sp² hybridized carbon sheets may be obtained. For example, the first graphene oxide product obtained through the second oxidation process in process 24 may have a structure of about 1 layer to several layers of sp² hybridized carbon sheets.

In process 20 of FIG. 1, during the forming of the first graphene oxide product by oxidizing the first reduced graphene oxide product obtained from process 10, particles of a reactant may be split by applying microwaves to the first reduced graphene oxide product and thus particle sizes may become smaller. The particle sizes of the reactant may become smaller if the time for applying microwaves to the first reduced graphene oxide product is longer. In the first reduced graphene oxide product, a carbon-carbon SP² double bond may be changed to a carbonyl group (—C═O), a carboxyl group (—COOH), hydroxyl (—OH), etc. through the oxidation process of process 20, and thus the carbon-carbon bond may break, and as a result, the particle sizes may become smaller.

In process 30 of FIG. 1, a second reduced graphene oxide product is formed by applying microwaves to the first graphene oxide product obtained from process 20.

In some exemplary embodiments, in applying microwaves to the first graphene oxide product in process 30, the first graphene oxide product may only include graphene oxide powder. In some other exemplary embodiments, the first graphene oxide product may include a polar solvent and graphene oxide powder dispersed in the polar solvent. A more detailed description of the polar solvent is provided with regard to the polar solvent in process 10. In some other exemplary embodiments, the first graphene oxide product may include a neutral or alkaline solution and graphene oxide dispersed in the neutral or alkaline solution. The neutral or alkaline solution may be a resultant obtained by neutralizing an acid solution. For example, after process 20, without separating or recovering the acid solution used in process 20, the neutral or alkaline solution may be obtained by applying an alkaline material such as NaOH or KOH to the first graphene oxide product and a reaction resultant in which the acid solution remains and neutralizing the acid solution remaining in the reaction resultant in which the acid solution remains.

A detailed method of applying microwaves to the first graphene oxide product in forming the second reduced graphene oxide product according to process 30 will be described with reference to FIGS. 10A and 10E later.

In process 40, at least one of an oxidation process of forming graphene oxide by applying microwaves to the second reduced graphene oxide product and oxidizing the second reduced graphene oxide product obtained from process 30 similarly to process 20 and a reduction process of forming reduced graphene oxide by applying microwaves to the graphene oxide and reducing the graphene oxide obtained as a resultant of the oxidation process similarly to process 30 is repeated at least once.

As described above, particle sizes of the graphene oxide or the reduced graphene oxide obtained by alternately repeating the oxidation process and the reduction process that are accompanied by application of microwaves with respect to the second reduced graphene oxide product obtained from process 30 gradually become smaller. In process 30, at least one of the oxidation process and the reduction process may be repeated until graphene dots including nanoparticles of about 1 nm˜about 10 nm are obtained. In some exemplary embodiments, graphene oxide quantum dots and/or reduced graphene oxide quantum dots (hereinafter referred to as “graphene quantum dots”) having a particle size of about 1 nm˜about 10 nm may be formed by alternately repeating the oxidation process and the reduction process that are accompanied by application of microwaves 3˜5 times with respect to the second reduced graphene oxide product obtained from process 30.

As described with reference to FIGS. 1 and 2 above, after forming the graphene oxide from graphite through a process of applying microwaves to the graphite, the reduced graphene oxide is formed from the obtained graphene oxide through the process of applying microwaves to the graphene oxide. Sizes of the graphene oxide and the reduced graphene oxide may gradually become smaller by alternately repeating the oxidation process and the reduction process that are accompanied by the process of applying microwaves with respect to the obtained reduced graphene oxide, thereby finally forming graphene quantum dots of about 1 nm˜about 10 nm.

In some exemplary embodiments, filtering and dialysis are performed on the graphene quantum dots formed as described above by using a membrane and a dialysis bag, and thus graphene quantum dots having various sizes may be separated. Quantum dots of a graphene substrate structure obtained as described above may have circular, oval, or polygonal shapes. In some other exemplary embodiments, edges of the graphene quantum dots may have a zigzag structure, an armchair structure, or a mixture structure thereof.

The acid solution that was already used in a graphite oxidation process or a reduced graphene oxide oxidation process that precedes the oxidation process of process 20 of FIG. 1 or process 40 may be recovered and recycled.

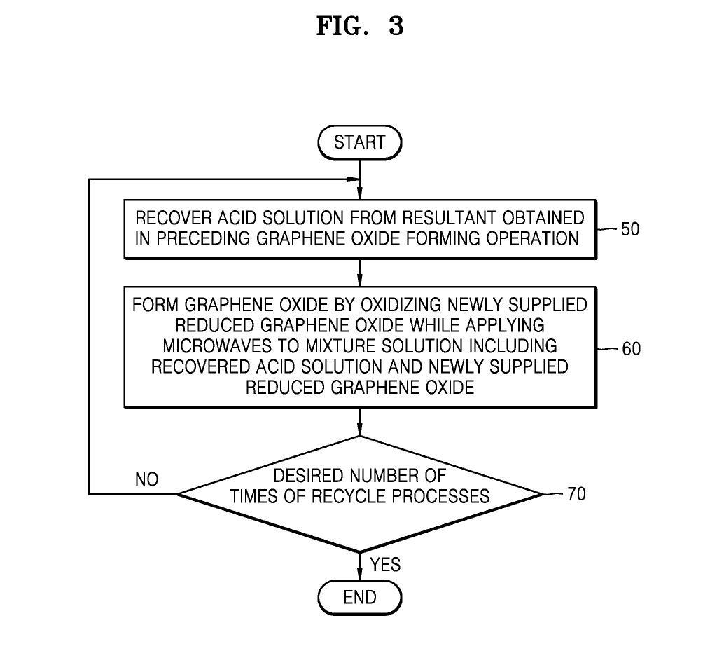

FIG. 3 is a flowchart for describing a recycle oxidation process that performs an oxidation process by reusing an acid solution used at least once in a preceding process in a method of forming a graphene quantum dot according to exemplary embodiments.

In FIG. 3, for convenience of description, an example of repeating process 20 of FIG. 1 by reusing the acid solution used in the oxidation process during the recycle oxidation process is described. However, the present invention is not limited thereto. For example, it is obvious that an oxidation process of process 40 of FIG. 1 or a graphite oxidation process for forming a graphene oxide material that is a reactant of FIG. 10 may be similarly used.

Referring to FIG. 3, in process 50, after performing a first oxidation process for forming a first graphene oxide product according to process 20 of FIG. 1, the acid solution is recovered from a resultant obtained during the first oxidation process.

In some exemplary embodiments, centrifugation may be used to recover the acid solution from a resultant of the first oxidation of process 20 of FIG. 1. For example, after a resultant obtained from the process of forming the first graphene oxide product is centrifuged, a remaining solution, except for a precipitate, may be recovered and used as a recycled acid solution.

In some other exemplary embodiments, filtering may be used to recover the acid solution from the resultant of the first oxidation of process 20 of FIG. 1. For example, after filtering the resultant obtained from the process of forming the first graphene oxide product through a filter, a remaining solution, except for a filtered residue, may be recovered and reused as a recycled acid solution.

In some other exemplary embodiments, a dialysis membrane may be used to recover the acid solution from the resultant of the first oxidation of process 20 of FIG. 1. For example, after placing the resultant obtained from the process of forming the first graphene oxide product in the dialysis membrane through which only acid is able to selectively pass, the acid that passes through the dialysis membrane may be recovered and reused as recycled acid. A first graphene oxide product may be recovered from a residue remaining in the dialysis membrane.

In process 60, a second oxidation process for forming the first graphene oxide product is performed by applying microwaves to a mixture solution containing the recovered acid solution and a first reduced graphene oxide product newly supplied as a resultant of process 10 of FIG. 1 and oxidizing the newly supplied first reduced graphene oxide product.

The mixture solution containing the newly supplied first reduced graphene oxide product may further include an oxidant. In some exemplary embodiments, at least a part of the oxidant necessary for the second oxidation process may be newly supplied. In some other exemplary embodiments, the oxidant may be included in the recovered acid solution. In this case, only a part of the oxidant necessary for the second oxidation process may be newly supplied. In some other exemplary embodiments, when the recovered acid solution includes the oxidant, before performing the second oxidation process, an amount of oxidant necessary for an oxidation reaction of the newly supplied first reduced graphene oxide product may be further added. A detailed description of the oxidant is the same as described with reference to FIG. 1 above.

In some exemplary embodiments, during the recycle oxidation process of process 60, the recovered acid solution and the newly added oxidant may be used to oxidize newly supplied graphite, instead of the newly supplied first reduced graphene oxide product.

To oxidize the first reduced graphene oxide product through the recycle oxidation process of process 60, as illustrated in FIG. 2, the first oxidation process of process 22 and the second oxidation process of process 24 may be sequentially performed.

In some exemplary embodiments, in performing process 60 of FIG. 3, microwaves of about 200˜about 800 W may be applied to the mixture solution containing the recovered acid solution and the newly supplied first reduced graphene oxide product for about 1˜about 30 minutes. In this regard, a detailed method of applying microwaves will be described with reference to FIGS. 10A through 10E later.

In process 70, it is determined whether the number of times the recycling oxidation process including processes 50 and 60 has been repeated is a desired number of times, and the recycling oxidation process including processes 50 and 60 is repeated until a desired amount and size of graphene oxide are obtained. In some exemplary embodiments, the recycling oxidation process including processes 50 and 60 may be repeated about 1 to 10 times, but is not limited thereto. The recycling oxidation process including processes 50 and 60 may be repeated about 10 or more times if necessary.

In some exemplary embodiments of forming the graphene quantum dot, an acid solution that was used in a preceding reduced graphene oxide oxidation process may be reused in a following reduced graphene oxide oxidation process, and thus the amount of acid used during the reduced graphene oxide oxidation process may be reduced by about two to tens of times, and the time taken for an oxidation reaction may be shortened by performing a graphite oxidation process using microwaves, and accordingly, productivity may be improved and thus mass production of the graphene quantum dot may be facilitated.

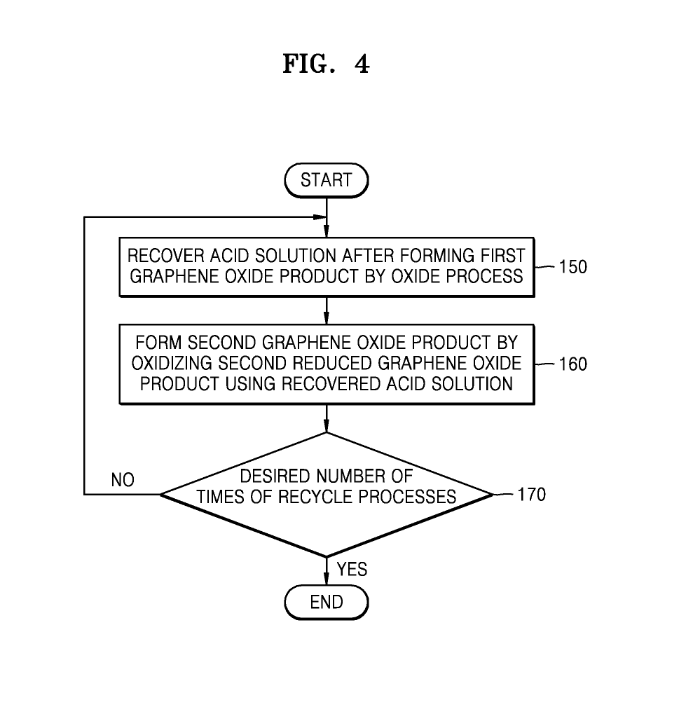

FIG. 4 is a flowchart for describing a recycle oxidation process that reuses acid in a method of forming a graphene quantum dot, according to other exemplary embodiments.

FIG. 4 illustrates a case where an acid solution used to form a first graphene oxide product in process 20 of FIG. 1 is reused to oxidize a second reduced graphene oxide product in process 40 of FIG. 1 again. However, the present invention is not limited thereto. For example, it is obvious that a case where an acid solution used in a preceding oxidation process is recovered and reused in a following oxidation process while alternately repeating oxidation and reduction processes in process 40 of FIG. 1 may be similarly applied.

In process 150, after forming the first graphene oxide product through the oxidation process in process 20 of FIG. 1, the acid solution used in the oxidation process is recovered.

In process 160, the recovered acid solution is used to oxidize the second reduced graphene oxide product and thereby form a second graphene oxide product. In this regard, an oxidant may be further added to a mixture solution containing the recovered acid solution and the second reduced graphene oxide product.

In process 170, it is determined whether the number of times the recycling oxidation process including processes 150 and 160 has been repeated is a desired number of times, and the recycling oxidation process including processes 150 and 160 is repeated until a desired number of times a recycling oxidation process is performed.

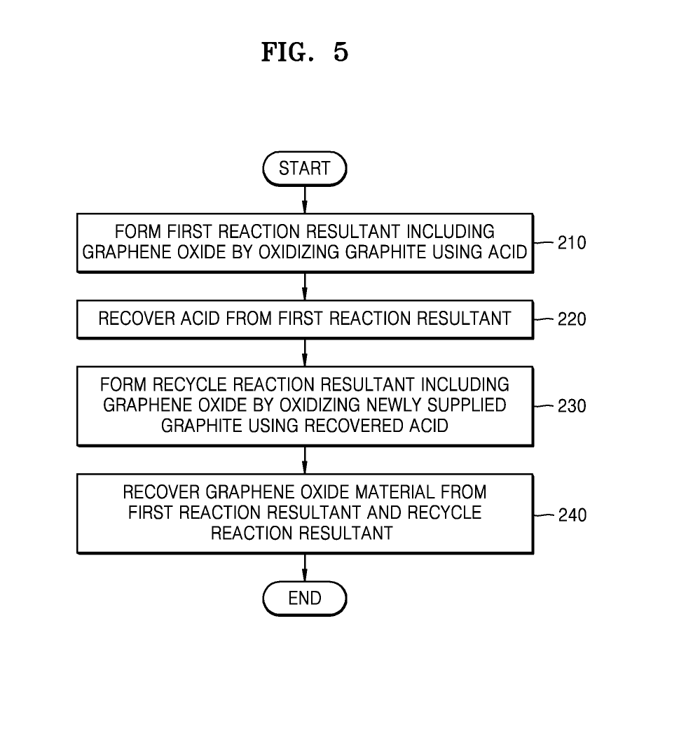

FIG. 5 is a flowchart for describing a recycle oxidation process that reuses an acid solution used at least once in a preceding process to obtain a graphene oxide material used as a reactant in process 10 of FIG. 1 before forming a first reduced graphene oxide product in process 10 in a method of forming a graphene quantum dot according to other exemplary embodiments.

In process 210, a first reaction resultant including graphene oxide is formed by oxidizing graphite by using acid.

In process 220, the acid is recovered from the first reaction resultant.

In process 230, a recycle reaction resultant including graphene oxide is formed by oxidizing newly supplied graphite by using the recovered acid.

In process 240, the graphene oxide material is recovered from the first reaction resultant obtained from process 220 and the recycle reaction resultant obtained from process 230.

In some exemplary embodiments, at least one of a process of forming the first reaction resultant from operation 220 and a process of forming the recycle reaction resultant from operation 230 may include the first oxidation process from operation 22 of FIG. 2 and the second oxidation process from operation 24.

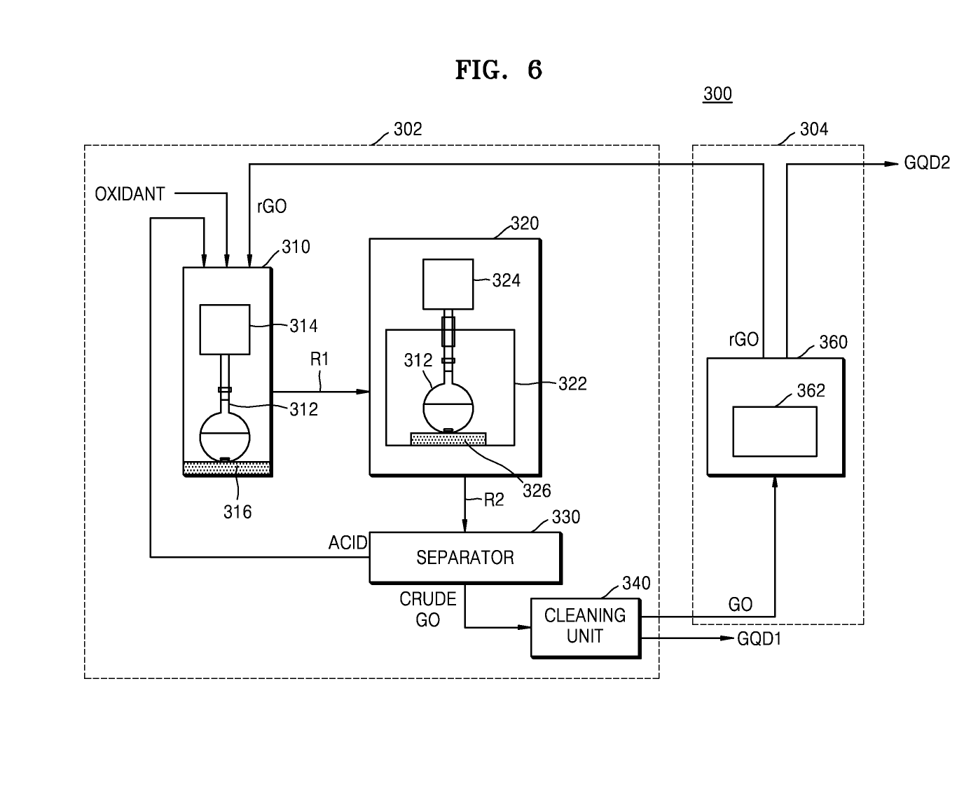

FIG. 6 is a schematic diagram illustrating a device 300 for forming a graphene quantum dot according to exemplary embodiments.

The device 300 for forming the graphene quantum dot includes an oxidation process unit 302 and a reduction process unit 304. The oxidation process unit 302 of the device 300 for forming the graphene quantum dot may be used to perform processes 20 and 40 of FIG. 1 and processes of FIGS. 2 through 5. The reduction process unit 304 of the device 300 for forming the graphene quantum dot may be used to perform processes 10, 30, and 40 of FIG. 1.

FIG. 6 illustrates a movement path of a reactant, a movement path of a reaction product, and a recycle path of an acid solution in the device 300 for forming the graphene quantum dot.

The oxidation process unit 302 of the device 300 for forming the graphene quantum dot includes an initial reactor 310, a microwave system 320, a separator 330, and a cleaning unit 340.

The initial reactor 310 may be used to perform a first oxidation process (for example, corresponding to process 22 of FIG. 2) of oxidizing a part of graphite or reduced graphene oxide during a graphite or reduced graphene oxide oxidation process.

The initial reactor 310 includes a container 312 for accommodating a mixture containing reactants necessary for oxidizing graphite, a cooler 314 for controlling the temperature of the mixture to prevent the mixture from overheating, and a stirrer 316 for stirring the mixture. The cooler 314 may be used to control the temperature of the mixture in the initial reactor 310 to not exceed a predetermined temperature, for example, 50° C.

The microwave system 320 may be used to perform a second oxidation process (corresponding to process 24 of FIG. 2) on an intermediate resultant R1 obtained from the first oxidation process. The intermediate resultant R1 may be moved, while being accommodated in the container 312, to the microwave system 320 from the initial reactor 310.

The microwave system 320 may include a microwave application unit 322, a cooler 324, and a stirrer 326. The stirrer 326 may be omitted according to circumstances.

While microwaves are applied to the reactant in the microwave application unit 322, the temperature of the reactant may be controlled using the cooler 324 to not exceed a predetermined temperature, for example, 60° C. While microwaves are applied to the reactant in the microwave application unit 322, the reactant may be stirred using the stirrer 326.

An intermediate resultant R2 obtained from the second oxidation process performed in the microwave system 320 may be separated into an acid solution ACID and a crude graphene oxide product CRUDE GO by the separator 330. In some exemplary embodiments, the separator 330 may include a centrifuge, a filter, or a dialysis membrane.

The acid solution ACID recovered in the separator 330 may be fed back to the initial reactor 310. The recovered acid solution ACID may be reused as a reactant for an oxidation process of newly supplied graphite or an oxidation process of reduced graphene oxide rGO transferred to the initial reactor 310 from the reduction process unit 304. In this regard, at least a part of an oxidant OXIDANT necessary for an oxidation reaction may be newly supplied.

In some exemplary embodiments, the cleaning unit 340 may include a cleaning bath for cleaning with hydrochloric acid and/or deionized water, a centrifuge, a dryer, and a clean bench. The cleaning unit 340 may perform a cleaning process of the crude graphene oxide product CRUDE GO to obtain graphene oxide GO. A graphene oxide quantum dot GQD1 including nanoparticles having a particle size having a predetermined value within the graphene oxide GO may be recovered as a final product. When the particle size of the graphene oxide GO is greater than the predetermined value, the graphene oxide GO may be transmitted to the reduction process unit 304 to undergo a reduction process again.

The reduction process unit 304 includes a reduction system 360 for reducing the graphene oxide GO. The reduction system 360 includes a microwave system 362. The microwave system 362 may have the same configuration as the microwave system 320 included in the oxidation process unit 302 but is not limited thereto.

The reduction system 360 may recover, as a final product, a reduced graphene oxide quantum dot GQD2 including nanoparticles having a particle size having a predetermined value within the reduced graphene oxide rGO obtained by reducing the graphene oxide GO by applying microwaves. If the particle size of the reduced graphene oxide rGO is greater than the predetermined value, the reduced graphene oxide rGO is supplied to the oxidation process unit 302. Thereafter, the oxidation process in the oxidation process unit 302 and the reduction process in the reduction process unit 304 may be repeatedly performed alternately until the desired graphene oxide quantum dot GQD1 or GQD2 is obtained from the reduced graphene oxide rGO.

Although the exemplary device 300 for forming the graphene quantum dot and an exemplary method of forming the graphene quantum dot using the device 300 are described with reference to FIG. 6, exemplary embodiments of the present invention are not limited thereto. That is, various changes in form and details may be made in the above-described exemplary embodiments without departing from the spirit and scope of the present invention.

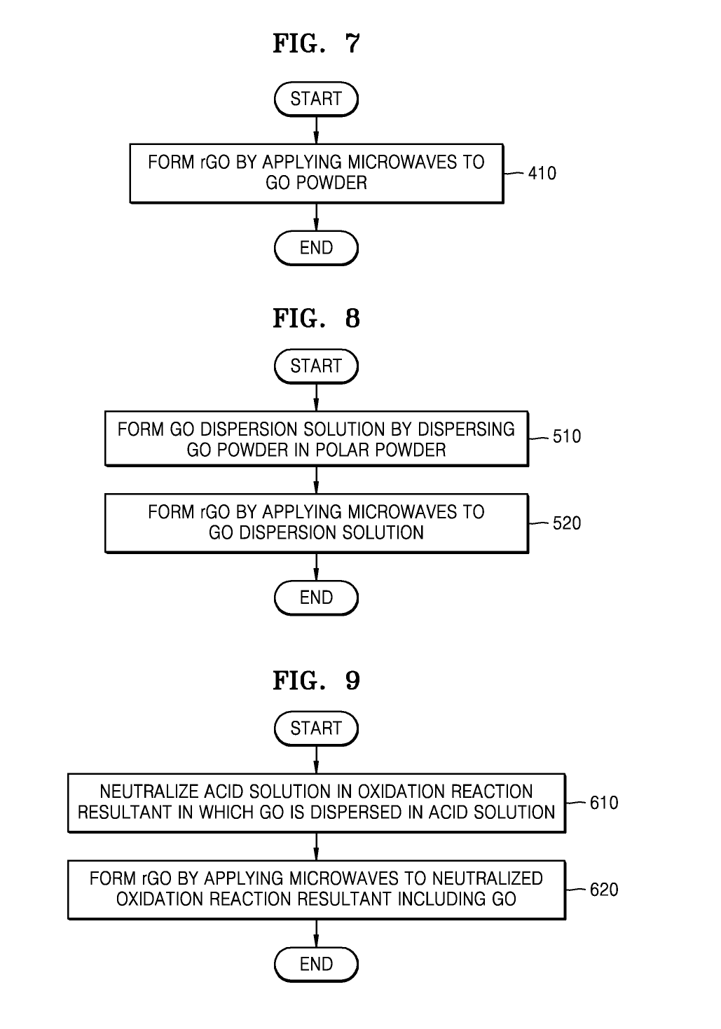

FIG. 7 is a flowchart for describing a reduction process according to an example of forming a reduced graphene oxide in a method of forming a graphene quantum dot according to exemplary embodiments. The reduction process illustrated in FIG. 7 may be applied to the reduction process, for example, in processes 10, 20, and/or 40 of FIG. 1.

In process 410, the reduced graphene oxide rGO is formed by directly applying microwaves to graphene oxide GO powder placed in a container.

In some exemplary embodiments, the graphene oxide GO powder may include a resultant of process 20 of FIG. 1, a resultant of FIG. 3, a resultant of FIG. 4, a resultant of FIG. 5, or graphene oxide powder for sale. In some exemplary embodiments, the graphene oxide GO powder may be a resultant obtained from an oxidation process in the oxidation process unit 302 of FIG. 6.

While microwaves are applied to the graphene oxide GO powder in operation 410, a reduction reaction of the graphene oxide GO takes place by microwaves.

FIG. 8 is a flowchart for describing a reduction process according to another example of forming a reduced graphene oxide in a method of forming a graphene quantum dot according to exemplary embodiments. The reduction process illustrated in FIG. 8 may be applied to the reduction process, for example, in processes 10, 20, and/or 40 of FIG. 1.

In process 510, a graphene oxide GO dispersion solution is formed by dispersing the graphene oxide GO powder in a polar solvent.

In some exemplary embodiments, the graphene oxide GO powder may include a resultant of process 20 of FIG. 1, a resultant of FIG. 3, a resultant of FIG. 4, a resultant of FIG. 5, or graphene oxide powder for sale. In some exemplary embodiments, the graphene oxide GO powder may be a resultant obtained from an oxidation process in the oxidation process unit 302 of FIG. 6. A more detailed description of the polar solvent is the same as described with reference to process 10 of FIG. 1.

In process 520, the reduced graphene oxide rGO is formed by applying microwaves to the graphene oxide GO dispersion solution.

While microwaves are applied to the graphene oxide GO powder dispersed in the polar solvent, a reduction reaction of the graphene oxide GO takes place by microwaves.

FIG. 9 is a flowchart for describing a reduction process according to another example of forming a reduced graphene oxide in a method of forming a graphene quantum dot according to exemplary embodiments. The reduction process illustrated in FIG. 9 may be applied to the reduction process, for example, in processes 10, 20, and/or 40 of FIG. 1.

In process 610, an acid solution is neutralized while the graphene oxide GO is included in an oxidation reaction resultant without refining the graphene oxide GO in the oxidation reaction resultant in which the graphene oxide GO is dispersed in the acid solution.

In some exemplary embodiments, the acid solution remaining in the oxidation reaction resultant may be neutralized by adding an alkaline material such as NaOH or KOH to the oxidation reaction resultant including the acid solution and the graphene oxide GO. As a result, the oxidation reaction resultant may include a neutral or alkaline solution.

In process 620, the reduced graphene oxide rGO is formed by applying microwaves to the neutralized oxidation reaction resultant including the graphene oxide GO.

While microwaves are applied to the graphene oxide GO dispersed in the neutralized oxidation reaction resultant, a reduction reaction of the graphene oxide GO takes place by microwaves.

The processes for forming the reduced graphene oxide illustrated in FIGS. 7 through 9 may be applied to processes for reducing a graphene oxide material, a first graphene oxide product, a second graphene oxide product, a third graphene oxide product, etc. (hereinafter, referred to as “graphene oxide material”) according to processes 10, 30, and 40 of FIG. 1. In some exemplary embodiments, the graphene oxide material may only include refined graphene oxide powder. In some other exemplary embodiments, the graphene oxide material may include a polar solvent and refined graphene oxide powder dispersed in the polar solvent. In some other exemplary embodiments, the graphene oxide material may include a neutral or alkaline solution obtained through a neutralization reaction on an acid solution after being used in an oxidation process, and non-refined graphene oxide dispersed in the acid solution.

The processes for forming the reduced graphene oxide illustrated in FIGS. 7 through 9 may be performed using the reduction process unit 304 of the device 300 for forming the graphene quantum dot illustrated in FIG. 6 but are not limited thereto.

A detailed method of applying microwaves in process 410 of FIG. 7, process 520 of FIG. 8, and process 620 of FIG. 9 will be described with reference to FIGS. 10A and 10E.

FIGS. 10A through 10E are graphs for describing various methods of applying microwaves according to exemplary embodiments. The methods of applying microwaves illustrated in FIGS. 10A through 10E may be applied to processes 10 through 40 of FIG. 1, process 24 of FIG. 2, process 60 of FIG. 3, process 160 of FIG. 4, processes 210 and 230 of FIG. 5, process 410 of FIG. 7, process 520 of FIG. 8, and process 620 of FIG. 9.

In some exemplary embodiments, in an oxidation process for forming graphene oxide or an oxidation process for forming reduced graphene oxide, microwaves P1 having a power level that is constant over time may be continuously applied to a reactant as illustrated in FIG. 10A.

In some other exemplary embodiments, in the oxidation process for forming graphene oxide or the oxidation process for forming reduced graphene oxide, microwaves P2 having a power level that increases over time may be continuously applied to the reactant, as illustrated in FIG. 10B.

In some other exemplary embodiments, in the oxidation process for forming graphene oxide or the oxidation process for forming reduced graphene oxide, microwaves P3 having a power level that stepwise increases over time may be continuously applied to the reactant, as illustrated in FIG. 10C.

In some other exemplary embodiments, in the oxidation process for forming graphene oxide or the oxidation process for forming reduced graphene oxide, microwaves P4 are applied to the reactant over time in a pulsed mode where the power of microwaves is alternately turned on and off to alternate a microwave application period and a microwave pause period, as illustrated in FIG. 10D. If microwaves are applied in such a pulsed mode, a temperature rise of the reactant may be comparatively easily suppressed during an oxidation or reduction reaction.

In some other exemplary embodiments, in the oxidation process for forming graphene oxide or the oxidation process for forming reduced graphene oxide, a process of applying microwaves P5 to the reactant may be performed as illustrated in FIG. 10E. In more detail, the process of applying microwaves P5 may include a first microwave application process I of continuously applying microwaves P5-1 having a power level that increases over time, a second microwave application process II of continuously applying microwaves P5-2 having a power level that is constant over time, and a third microwave application process III of continuously applying microwaves P5-3 having a power level that decreases over time.

In performing the oxidation process for forming graphene oxide or the oxidation process for forming reduced graphene oxide while applying microwaves in each of the application manners, as illustrated in FIGS. 10A through 10E, the oxidation process or the reduction process may be performed while controlling a reaction temperature not to excessively rise.

Microwaves are used to reduce graphene oxide in the processes of forming the reduced graphene oxide illustrated in FIGS. 7 through 9 but the exemplary embodiments of the present invention are not limited thereto.

In a method of forming a graphene quantum dot according to embodiments, a thermal process may be used to reduce the graphene oxide. For example, a method of placing a graphene oxide material in an autoclave and heating the graphene oxide material in a furnace at a temperature from about 200° C.˜about 300° C. may be used. Alternatively, a deoxygenation reaction may be induced by heating the graphene oxide material in an organic solvent. The organic solvent may include an alkaline aqueous solution, distilled water, dimethylformamide (DMF), dimethyl acetamide (DMA), or N-methyl-2-pyrrolidinone (NMP).

In the method of forming a graphene quantum dot according to embodiments, a chemical method of using a reductant may be used to reduce the graphene oxide. For example, hydrazine, sodium hydride, hydroquinone, sodium borohydride (NaBH₄), and a HI/CH₃COOH mixture may be used as the reductant. Alternatively, ascorbic acid or a glucose reductant may be used as an environmentally-friendly reductant.

In the method of forming a graphene quantum dot according to embodiments, a hydrogen plasma processing method, an electrochemical reduction method, a photo catalysis method, etc. may be used to reduce the graphene oxide.

The graphene oxide quantum dot GQD1 and the reduced graphene oxide quantum dot GQD2 recovered from the device 300 for forming the graphene quantum dot described with reference to FIG. 6 may be refined and recovered by using various methods.

In some exemplary embodiments, when reduced graphene oxide is formed by applying microwaves to graphene oxide powder, as illustrated in FIG. 7, the reduced graphene oxide rGO and the reduced graphene oxide quantum dot GQD2 recovered from the reduction process unit 304 of the device 300 forming the graphene quantum dot may be placed in a dialysis membrane through which only particles smaller than a predetermined value may pass, and then the dialysis membrane may be placed in a beaker containing water, and thus, the reduced graphene oxide rGO or the reduced graphene oxide quantum dot GQD2 having a particle size smaller than the predetermined value may selectively pass through the dialysis membrane. Thereafter, a final product of the reduced graphene oxide rGO or the reduced graphene oxide quantum dot GQD2 may be obtained by evaporating water. Similarly, only the graphene oxide GO or the graphene oxide quantum dot GQD1 having the particle size smaller than the predetermined value may be recovered from the graphene oxide GO or the graphene oxide quantum dot GQD1 recovered from the oxidation process unit 302 of the device 300 for forming the graphene quantum dot described with reference to FIG. 6. Thereafter, the graphene oxide GO or the graphene oxide quantum dot GQD1 having a desired size may be obtained by evaporating water.

In some other exemplary embodiments, when the reduced graphene oxide is formed by applying microwaves to graphene oxide powder dispersed in a polar solvent, as illustrated in FIG. 8, or when the reduced graphene oxide is formed by applying microwaves to graphene oxide included in a solution obtained by neutralizing an acid solution, as illustrated in FIG. 9, the reduced graphene oxide rGO and the reduced graphene oxide quantum dot GQD2 recovered from the reduction process unit 304 of the device 300 forming the graphene quantum dot may be placed in a dialysis membrane through which only a solvent or solutions may pass, and then the dialysis membrane may be placed in a tank containing water, and thus the solvent or solutions may selectively pass through the dialysis membrane, thereby recovering the reduced graphene oxide rGO or the reduced graphene oxide quantum dot GQD2 remaining in the dialysis membrane. Similarly, the graphene oxide GO or the graphene oxide quantum dot GQD1 may be recovered by refining the intermediate resultant R2 obtained through a second oxidation process in the microwave system 320 of the oxidation process unit 302 of the device 300 for forming the graphene quantum dot described with reference to FIG. 6.

Detailed examples of forming a graphene quantum dot according to exemplary embodiments will be described below.

### Example 1

### Forming Graphene Oxide

After 1 g of graphite powder was added to a mixture of 120 mL of sulfuric acid (H₂SO₄) and 14 mL of phosphoric acid (H₃PO₄) in a reaction container, 6 g of potassium permanganate (KMnO₄) was slowly added thereto and stirred for about 5 minutes while maintaining the temperature at about 8° C.

The reaction container was put into a microwave system that was kept at about 40° C., and then microwaves of about 500 W were applied to the mixture for about 20 minutes to induce an oxidation reaction of graphite.

The resulting oxidation reaction product was cooled down to room temperature, and then poured onto ice together with 2 mL of a 30% hydrogen peroxide (H₂O₂) to obtain a cooled graphene oxide solution.

The obtained graphene oxide solution was centrifuged at about 6,000 rpm for about 90 minutes to separate the obtained graphene oxide solution into the acid solution and a crude graphene oxide product.

Next, a recycling process of oxidizing graphite through a recycling oxidation process using the separated acid solution was repeated 7 times to further yield the crude graphene oxide product 7 times. In each of the seven recycling oxidation processes, after the acid solution used in the preceding graphene oxide formation process was recovered and added into the reaction container, 1 g of graphite was added to the reaction container, and then 6 g of potassium permanganate was slowly added to the reaction container, followed by stirring for about 5 minutes while maintaining the temperature at about 8° C. and oxidizing graphite while applying microwaves in the same manner as in the first oxidation process.

Subsequently, graphite was oxidized while applying microwaves in the same manner as in the oxidation process for obtaining the first graphene oxide.

About 1 L of distilled water was added to the resulting crude graphene oxide product obtained through the oxidation processes as described above, and stirred for about 2 hours, followed by adding about 2 mL of a 10% H₂O₂ solution to terminate the reaction, thereby obtaining brightly yellow graphene oxide.

The resulting product was centrifuged at about 6000 rpm for about 90 minutes to collect the precipitate. A 10% HCl was added to the collected precipitate, stirred for about 2 hours, and then centrifuged at about 6000 rpm for about 90 minutes to collect the precipitate. Deionized water was added to the collected precipitate and centrifuged at about 6000 rpm for about 90 minutes to collect the precipitate. Deionized water was added to the collected precipitate, stirred for about 5 hours, and then centrifuged at about 6000 rpm for about 90 minutes to collect the precipitate. Deionized water was then added to the collected precipitate and centrifuged at about 1000 rpm for about 2 minutes to collect the precipitate. The final collected precipitate was dried in a clean bench to obtain graphene oxide having a smaller particle size.

### Example 2

### Forming Reduced Graphene Oxide

After dispersing the graphene oxide obtained in Example 1 in water accommodated in a container, the graphene oxide was reduced by applying microwaves of about 300 W for about 10 minutes, and thus reduced graphene oxide was formed.

### Example 3

### Forming Reduced Graphene Oxide

By alternately repeating an oxidation process of Example 1 and a reduction process of Example 2 with respect to the reduced graphene oxide obtained in Example 2 5 times, a graphene oxide quantum dot and a reduced graphene oxide quantum dot having a particle size of about 1 nm˜about 10 nm were formed.

FIG. 11 is a graph illustrating a result of measuring an ultraviolet-visible (UV-Vis) spectrum of a reduced graphene oxide quantum dot obtained in Example 3. In FIG. 11, an excitation spectrum has a highest photoluminescence (PL) intensity at about 403 nm, and a light emitting spectrum has a highest PL intensity at about 508 nm, according to absorption of light.

While one or more embodiments of the present invention have been described with reference to the figures, it will be understood by those of ordinary skill in the art that various changes in form and details may be made therein without departing from the spirit and scope of the present invention as defined by the following claims.

### INDUSTRIAL APPLICABILITY

One or more embodiments provide a method of forming a graphene quantum dot. The graphene quantum dot according to the above-described embodiments may be used in electronic devices, for example, in electrodes of a panel used for, for example, a liquid crystal display (LCD), a plasma display, or the like; electrodes of a display device such as a laptop computer, a mobile phone, a touch panel, or the like; electrodes of various batteries such as liquid ion batteries, lithium ion capacitors, fuel cells, thin-filmed solar cells, primary batteries, and secondary batteries; electrodes for electric-discharge machining; parts of semiconductor manufacturing apparatuses; parts of ion injection apparatuses; continuous casting members; heat sinks; heat exchangers, and the like.

1. A method of forming a graphene quantum dot, the method comprising:
forming a first reduced graphene oxide product by applying microwaves to a graphene oxide material;
forming a first graphene oxide product by oxidizing the first reduced graphene oxide product while applying microwaves to a mixture solution including an acid solution, a first oxidant, and the first reduced graphene oxide product; and
forming a second reduced graphene oxide product by applying microwaves to the first graphene oxide product.

2. The method of claim 1, wherein the forming of the first graphene oxide product comprises:
a first oxidization operation of oxidizing the first reduced graphene oxide product at a first temperature that does not exceed 50° C.; and
a second oxidization operation of oxidizing the first reduced graphene oxide product while applying microwaves to the first reduced graphene oxide.

3. The method of claim 1, further comprising: after forming the second reduced graphene oxide product, forming graphene dots comprising nanoparticles of about 1 nm˜about 10 nm by alternately repeating an oxidation process using application of microwaves to the second reduced graphene oxide product and a reduction process using application of microwaves.

4. The method of claim 1, wherein the graphene oxide material comprises graphene oxide powder.

5. The method of claim 1, wherein the graphene oxide material comprises a polar solvent and graphene oxide powder dispersed in the polar solvent.

6. The method of claim 5, wherein the polar solvent comprises water or an organic solvent.

7. The method of claim 1, wherein the graphene oxide material comprises a neutral or alkaline solution and graphene oxide dispersed in the neutral or alkaline solution.

8. The method of claim 1, wherein at least one of forming the first reduced graphene oxide product, forming the first graphene oxide product, and forming the second reduced graphene oxide product comprises: continuously applying microwaves having a power level that is constant over time.

9. The method of claim 1, wherein at least one of forming the first reduced graphene oxide product, forming the first graphene oxide product, and forming the second reduced graphene oxide product comprises: continuously applying microwaves having a power level that increases over time.

10. The method of claim 1, wherein at least one of forming the first reduced graphene oxide product, forming the first graphene oxide product, and forming the second reduced graphene oxide product comprises: continuously applying microwaves in a pulsed mode where a microwave application period and a microwave pause period are alternately repeated.

11. The method of claim 1, wherein at least one of forming the first reduced graphene oxide product, forming the first graphene oxide product, and forming the second reduced graphene oxide product comprises:
a first microwave application operation of continuously applying microwaves having a power level that increases over time;
a second microwave application operation of continuously applying microwaves having a power level that is constant over time; and
a third microwave application operation of continuously applying microwaves having a power level decreases over time.

12. The method of claim 1, further comprising: after forming the second reduced graphene oxide product, forming a second graphene oxide product of a fourth size that is smaller than a second size by oxidizing the second reduced graphene oxide product while applying microwaves to a mixture solution including the acid solution and the second reduced graphene oxide product.

13. The method of claim 12, further comprising: after forming the first graphene oxide product, recovering the acid solution,
wherein the forming of the second graphene oxide product comprises: oxidizing the second reduced graphene oxide product by using the recovered acid solution and a second oxidant.

14. The method of claim 1, further comprising: before forming the first reduced graphene oxide product,
forming a first reaction resultant comprising graphene oxide by oxidizing graphite by using acid;
recovering the acid from the first reaction resultant;
forming a recycle reaction resultant comprising the graphene oxide by oxidizing newly supplied graphite by using the recovered acid; and
recovering the graphene oxide material from the first reaction resultant and the recycle reaction resultant.

15. The method of claim 14, wherein at least one of forming the first reaction resultant and forming the recycle reaction resultant comprises:
a first oxidization operation of oxidizing graphite at a first temperature that does not exceed 50° C.; and
a second oxidization operation of oxidizing the graphite while applying microwaves.

16. The method of claim 1, wherein the graphene oxide material has a structure of 1 to 10 layers of sp² hybridized carbon sheets.

17. A method of forming a graphene quantum dot, the method comprising:
forming a reduced graphene oxide product by reducing a graphene oxide material using microwaves;
a repetitive oxidation operation of forming a graphene oxide product by oxidizing the reduced graphene oxide product again;
a repetitive reduction operation of forming the reduced graphene oxide product by reducing the graphene oxide product again using microwaves; and
repeating at least one of the repetitive oxidation operation and the repetitive reduction operation with respect to the reduced graphene oxide product obtained in the repetitive reduction operation at least once.

18. The method of claim 17, further comprising: before forming the reduced graphene oxide product, forming a reaction resultant in which graphene oxide is dispersed in an acid solution by oxidizing graphite or newly supplied reduced graphene oxide using the acid solution and an oxidant.

19. The method of claim 18, further comprising: forming graphene oxide powder refined by separating the graphene oxide from the reaction resultant,
wherein the graphene oxide material comprises the refined graphene oxide powder.

20. The method of claim 18, further comprising: forming a neutral or alkaline solution by neutralizing the acid solution included in the reaction resultant,
wherein the graphene oxide material comprises the neutral or alkaline solution and graphene oxide dispersed in the neutral or alkaline solution.
